(19) United States
(12) Patent Application Publication
(10) Pub. No.: US 2018/0025438 A1
(43) Pub. Date: Jan. 25, 2018

(54) SYSTEM AND METHOD FOR GENERATING ANALYTICS BASED ON ELECTRONIC DOCUMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/674,165

(22) Filed: Aug. 10, 2017

Related U.S. Application Data
(63) Continuation-in-part of application No. 15/361,934, filed on Nov. 28, 2016.
(60) Provisional application No. 62/374,855, filed on Aug. 14, 2016.
(60) Provisional application No. 62/260,553, filed on Nov. 29, 2015.
(60) Provisional application No. 62/261,355, filed on Dec. 1, 2015.

(51) Int. Cl. G06Q 40/00; G06Q 20/34

(52) U.S. Cl. CPC G06Q 40/123; G06Q 20/34

(57) ABSTRACT

A system and method generating analytics based on electronic documents. The method includes analyzing the electronic document to determine at least one transaction parameter, the electronic document indicating a transaction including use of a payment card with respect to at least one expense, wherein the electronic document includes at least partially unstructured data; creating a template for the electronic document, wherein the template is a structured dataset including the determined at least one transaction parameter; retrieving, based on the template, at least one deductibility rule for generating deductibility analytics; and generating at least one deductibility analytic based on the template, at least one enterprise characteristic parameter of an enterprise associated with the payment card, and the retrieved at least one deductibility rule, wherein the at least one deductibility analytic indicates at least whether each of the at least one expense is deductible.

### CROSS-REFERENCE TO RELATED APPLICATIONS

This application claims the benefit of U.S. Provisional Application No. 62/374,855 filed on Aug. 14, 2016. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. The contents of the above-referenced applications are hereby incorporated by reference.

### TECHNICAL FIELD

The present disclosure relates generally to analyzing electronic documents, and more particularly to generating analytics based on electronic documents.

### BACKGROUND

Customers can place orders for services such as travel and accommodations from merchants in real-time over the web. These orders can be received and processed immediately. However, payments for the orders typically require more time to complete and, in particular, to secure the money being transferred. Therefore, merchants typically require the customer to provide assurances of payment in real-time while the order is being placed. As an example, a customer may input credit card information pursuant to a payment, and the merchant may verify the credit card information in real-time before authorizing the sale. The verification typically includes determining whether the provided information is valid (i.e., that a credit card number, expiration date, PIN code, and/or customer name match known information).

Upon receiving such assurances, a purchase order may be generated for the customer. The purchase order provides evidence of the order such as, for example, a purchase price, goods and/or services ordered, and the like. Later, an invoice for the order may be generated. While the purchase order is usually used to indicate which products are requested and an estimate or offering for the price, the invoice is usually used to indicate which products were actually provided and the final price for the products. Frequently, the purchase price as demonstrated by the invoice for the order is different from the purchase price as demonstrated by the purchase order. As an example, if a guest at a hotel initially orders a 3-night stay but ends up staying a fourth night, the total price of the purchase order may reflect a different total price than that of the subsequent invoice. Cases in which the total price of the invoice is different from the total price of the purchase order are difficult to track, especially in large enterprises accepting many orders daily (e.g., in a large hotel chain managing hundreds or thousands of hotels in a given country). The differences may cause errors in recordkeeping for enterprises.

As businesses increasingly rely on technology to manage data related to operations such as invoice and purchase order data, suitable systems for properly managing and validating data have become crucial to success. Particularly for large businesses, the amount of data utilized daily by businesses can be overwhelming. Accordingly, manual review and validation of such data is impractical, at best. However, disparities between recordkeeping documents can cause significant problems for businesses such as, for example, failure to properly report earnings to tax authorities.

Some solutions exist for automatically recognizing information in scanned documents (e.g., invoices and receipts) or other unstructured electronic documents (e.g., unstructured text files). Such solutions often face challenges in accurately identifying and recognizing characters and other features of electronic documents. Moreover, degradation in content of the input unstructured electronic documents typically result in higher error rates. As a result, existing image recognition techniques are not completely accurate under ideal circumstances (i.e., very clear images), and their accuracy often decreases dramatically when input images are less clear. Moreover, missing or otherwise incomplete data can result in errors during subsequent use of the data. Many existing solutions cannot identify missing data unless, e.g., a field in a structured dataset is left incomplete.

In addition, existing image recognition solutions may be unable to accurately identify some or all special characters (e.g., “!,” “@,” “#,” “$,” “©,” “%,” “&,” etc.). As an example, some existing image recognition solutions may inaccurately identify a dash included in a scanned receipt as the number “1.” As another example, some existing image recognition solutions cannot identify special characters such as the dollar sign, the yen symbol, etc.

Further, such solutions may face challenges in preparing recognized information for subsequent use. Specifically, many such solutions either produce output in an unstructured format, or can only produce structured output if the input electronic documents are specifically formatted for recognition by an image recognition system. The resulting unstructured output typically cannot be processed efficiently. In particular, such unstructured output may contain duplicates, and may include data that requires subsequent processing prior to use.

Business expenses are expenses made as the cost of carrying on a trade or business. These expenses are often deductible. Deductible expenses are expenses that are subtracted from a company's income before it is subject to taxation. Standard business deductions may include, for example, general and administrative expenses, business-related travel and entertainment expenses, automobile expenses, and employee benefits. Some business expenses are “current” and must be deducted in the year that they are paid, while others are “capitalized” and, therefore, are spread out or depreciated over time.

There are some business expenses that are prohibited by law from deducting, such as bribes, traffic tickets, clothing that is not a uniform, and unreasonably large expenses (such as a large jet for a small local business). The rules and laws for expense deductions vary by jurisdiction, and therefore may be challenging to apply correctly. In particular, large multi-national corporations may face challenges in identifying which expenses are deductible. This problem is further compounded when evidencing documents (e.g., receipts and invoices) include unstructured data, which may result in inefficient or inaccurate processing. The challenges in identifying deductible expenses is a serious issue, as improper submissions may carry legal penalties and withholding submissions for fear of such penalties may result in loss of money.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for generating analytics based on an electronic document. The method comprises: analyzing the electronic document to determine at least one transaction parameter, the electronic document indicating a transaction including use of a payment card with respect to at least one expense, wherein the electronic document includes at least partially unstructured data; creating a template for the electronic document, wherein the template is a structured dataset including the determined at least one transaction parameter; retrieving, based on the template, at least one deductibility rule for generating deductibility analytics; and generating at least one deductibility analytic based on the template, at least one enterprise characteristic parameter of an enterprise associated with the payment card, and the retrieved at least one deductibility rule, wherein the at least one deductibility analytic indicates at least whether each of the at least one expense is deductible.

Certain embodiments disclosed herein also include a non-transitory computer readable medium having stored thereon instructions for causing a processing circuitry to perform a process for generating analytics based on an electronic document, the process comprising: analyzing the electronic document to determine at least one transaction parameter, the electronic document indicating a transaction including use of a payment card with respect to at least one expense, wherein the electronic document includes at least partially unstructured data; creating a template for the electronic document, wherein the template is a structured dataset including the determined at least one transaction parameter; retrieving, based on the template, at least one deductibility rule for generating deductibility analytics; and generating at least one deductibility analytic based on the template, at least one enterprise characteristic parameter of an enterprise associated with the payment card, and the retrieved at least one deductibility rule, wherein the at least one deductibility analytic indicates at least whether each of the at least one expense is deductible.

Certain embodiments disclosed herein also include a system for generating analytics based on an electronic document. The system comprises: a processing circuitry; and a memory, the memory containing instructions that, when executed by the processing circuitry, configure the system to: analyze the electronic document to determine at least one transaction parameter, the electronic document indicating a transaction including use of a payment card with respect to at least one expense, wherein the electronic document includes at least partially unstructured data; create a template for the electronic document, wherein the template is a structured dataset including the determined at least one transaction parameter; retrieve, based on the template, at least one deductibility rule for generating deductibility analytics; and generate at least one deductibility analytic based on the template, at least one enterprise characteristic parameter of an enterprise associated with the payment card, and the retrieved at least one deductibility rule, wherein the at least one deductibility analytic indicates at least whether each of the at least one expense is deductible.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a validation system according to an embodiment.

FIG. 3 is a flowchart illustrating a method for generating analytics based on electronic documents according to an embodiment.

FIG. 4 is a flowchart illustrating a method for creating a dataset based on at least one electronic document according to an embodiment.

### DETAILED DESCRIPTION

[0021]It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for generating analytics based on electronic documents. In an embodiment, a dataset is created based on an evidencing electronic document indicating information related to a transaction and, specifically, a transaction involving use of a payment card. The transaction includes one or more expenses. A template of transaction attributes is created based on the dataset.

Based on the created template, rules for generating analytics are retrieved. The rules may be retrieved from one or more web sources selected based on the transaction attributes, and may include, but are not limited to, rules for determining whether an expense is deductible, rules for determining whether a tax paid can be reclaimed for a transaction (e.g., a value-added tax paid abroad). Based on the retrieved rules and the created template, analytics are generated. In some implementations, the analytics may be further generated based on one or more characteristics of an enterprise.

In an example implementation, the evidencing electronic document is a scanned image or electronic receipt including data related to use of a payment card in a transaction. To this end, the evidencing electronic document may be retrieved from a server of a payment card supplier such as, for example, a credit card company or bank. The data in the evidencing electronic document may be, for example, unstructured data extracted using OCR, or structured data in a format not recognized by the analytics generator (e.g., in a format that is specific to the payment card supplier). Thus, the created templates allow for more efficient and accurate utilization of the data than, for example, using the unstructured or unrecognized structure data directly. Specifically, rules and enterprise characteristic parameters may be retrieved based on data in particular fields of the structured template rather than comparing all data in the electronic document. Additionally, rules may be applied with respect to predetermined fields containing relevant data (e.g., applying a rule related to price to data in a “price” field), thereby increasing efficiency of rules application and reducing false positives and negatives (e.g., due to applying rules to inappropriate or irrelevant data).

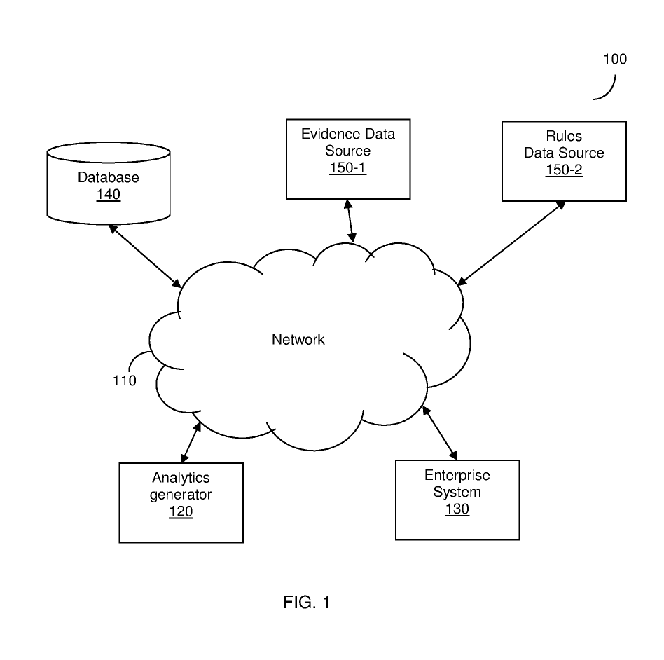

FIG. 1 shows an example network diagram 100 utilized to describe the various disclosed embodiments. In the example network diagram 100, an analytics generator 120, an enterprise system 130, a database 140, an evidence data source 150-1, and a rules data source 150-2, are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store enterprise characteristic parameters indicating characteristics of the enterprise such as, but not limited to, country of formation, revenue data, structural data, and the like. The enterprise system 130 may be, but is not limited to, a server, a database, an enterprise resource planning system, a customer relationship management system, or any other system storing relevant data.

The database 140 may store analytics generated by the analytics generator 120, and may further store associated evidencing electronic documents.

The evidence data source 150-1 stores at least evidencing electronic documents including data related to transactions. The evidencing electronic documents may indicate uses of payment cards and may include, for example, invoices, receipts, purchase orders, and the like. In an example implementation, the evidence data source 150-1 is a server of a payment card company such as, for example, a credit card company.

The rules data source 150-2 stores at least rules for generating analytics based on transactions indicated in the evidencing electronic documents. In an example implementation, the rules may define expenses that may be deducted (e.g., based on types, amounts, enterprise characteristics, etc.), value-added taxes (VATs) that may be reclaimed, or both. To this end, the rules data source 150-2 may be, but is not limited to, servers or devices of merchants, tax authority servers, accounting servers, a database associated with an enterprise, and the like. As a non-limiting example, rules data source 150-2 may be a tax authority server storing deduction rules for expenses incurred in a particular country.

In an embodiment, the analytics generator 120 is configured to create a template based on transaction parameters identified using machine vision of an evidencing electronic document indicating information related to a transaction involving use of a payment card and including one or more expenses. The analytics generator 120 may be configured to retrieve the evidencing electronic document from the evidence data source 150-1. Based on the created template, the analytics generator 120 is configured to retrieve, from the rules data source 150-2, rules for generating analytics based on the template.

In some implementations, the analytics generator 120 may be configured to retrieve the rules based further on one or more enterprise characteristic parameters of an enterprise. To this end, the analytics generator 120 may be configured to retrieve the enterprise characteristic parameters from the enterprise system 130. The enterprise system 130 may be selected from among multiple data sources storing enterprise characteristic parameters based on data included in the template. For example, based on credit card number indicated in a “payment card identifier” field of the template, an enterprise system associated with the credit card number may be selected

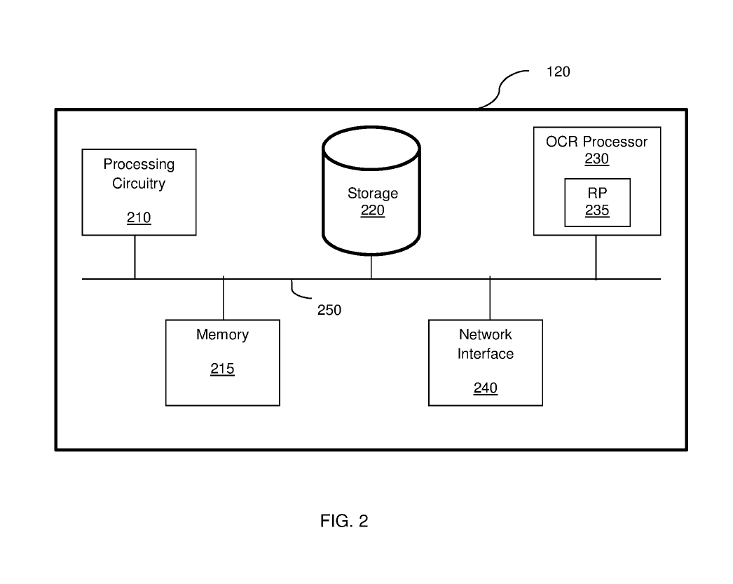

In an embodiment, the analytics generator 120 is configured to create datasets based on electronic documents including data at least partially lacking a known structure (e.g., unstructured data, semi-structured data, or structured data having an unknown structure). To this end, the analytics generator 120 may be further configured to utilize optical character recognition (OCR) or other image processing to determine data in the electronic document. The analytics generator may therefore include or be communicatively connected to a recognition processor (e.g., the recognition processor 235, FIG. 2).

In an embodiment, the analytics generator 120 is configured to analyze a dataset for an evidencing electronic document to identify transaction parameters related to transactions indicated in the evidencing electronic document. The transaction parameters indicate information of one or more expenses paid for using a payment card. In an example implementation, the transaction parameters indicate at least an amount for each expense (e.g., a price of each item purchased), one or more identifiers of a point of sale (e.g., a location, a name, a type of business, etc.), and one or more identifiers of a payment card (e.g., a credit card number). The analytics generator 120 is configured to create a template based on the dataset. The template is a structured dataset including the identified transaction parameters for a transaction.

In an embodiment, based on the template, the analytics generator 120 is configured to retrieve one or more rules for generating analytics. The rules may be further retrieved based on the enterprise characteristics. The rules may be retrieved with respect to one or more types of analytics to be generated (e.g., whether a deduction is possible, whether a VAT reclaim is possible, an amount of deduction or reclaim, etc.). The rules may include, but are not limited to, rules for determining whether expenses are deductible, rules for determining whether VATs can be reclaimed, rules for determining amounts of deductions or reclaims, and the like. For example, deduction rules may be retrieved based on the country of formation of the business, the structure of the enterprise, the most recent annual revenue for the enterprise, combinations thereof, and the like. As another example, VAT reclaim rules may be retrieved based on a location of the transaction.

Using structured templates for generating analytics for more efficient and accurate generation of analytics than, for example, by utilizing unstructured data. Specifically, corresponding rules may be retrieved and analyzed only with respect to relevant portions of data in an electronic document (e.g., portions included in specific fields of a structured template), thereby reducing the number of instances of application of each rule as well as reducing false positives due to applying rules to unrelated data.

In an embodiment, the analytics generator 120 is configured to apply the retrieved rules to data of the template, the enterprise characteristic parameters, or a combination thereof. Based on the results of the rules application, the analytics generator 120 is configured to generate analytics indicating, for example, whether each expense is deductible, whether VATs paid for the transaction can be reclaimed, and the like. The analytics generator 120 may be further configured to generate a notification including the generated analytics, the evidencing electronic document, or both. The generated notification may be sent to, for example, the enterprise system 130, a user device (not shown) associated with the enterprise, and the like.

It should be noted that the embodiments described herein above with respect to FIG.

1 are described with respect to the enterprise system 130 and two data sources 150-1 and 150-2 merely for simplicity purposes and without limitation on the disclosed embodiments. More, fewer, or different sources of data may be utilized for retrieving electronic documents, rules, enterprise characteristic parameters, and the like, without departing from the scope of the disclosure. As a non-limiting example, an evidencing electronic document may be retrieved from the evidence data source 150-1, and both the rules and the enterprise characteristic parameters may be retrieved from the enterprise system 130 (i.e., the rules data source 150-2 may not be needed for retrieval of data). As another example, multiple evidence data sources, rules data source, or sources of enterprise characteristic data, and the like, may be utilized.

FIG. 2 is an example schematic diagram of the analytics generator 120 according to an embodiment. The analytics generator 120 includes a processing circuitry 210 coupled to a memory 215, a storage 220, and a network interface 240. In an embodiment, the analytics generator 120 may include an optical character recognition (OCR) processor 230. In another embodiment, the components of the analytics generator 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to generate consolidated data based on electronic documents, as discussed herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition processor (RP) 235 configured to identify patterns, features, or both, in unstructured data sets. Specifically, in an embodiment, the OCR processor 230 is configured to identify at least characters in the unstructured data. The identified characters may be utilized to create a dataset including data required for verification of a request.

The network interface 240 allows the analytics generator 120 to communicate with the enterprise system 130, the database 140, the web sources 150-1 and 150-2, or a combination of, for the purpose of, for example, retrieving data, storing data, and the like.

It should be understood that the embodiments described herein are not limited to the specific architecture illustrated in FIG. 2, and other architectures may be equally used without departing from the scope of the disclosed embodiments.

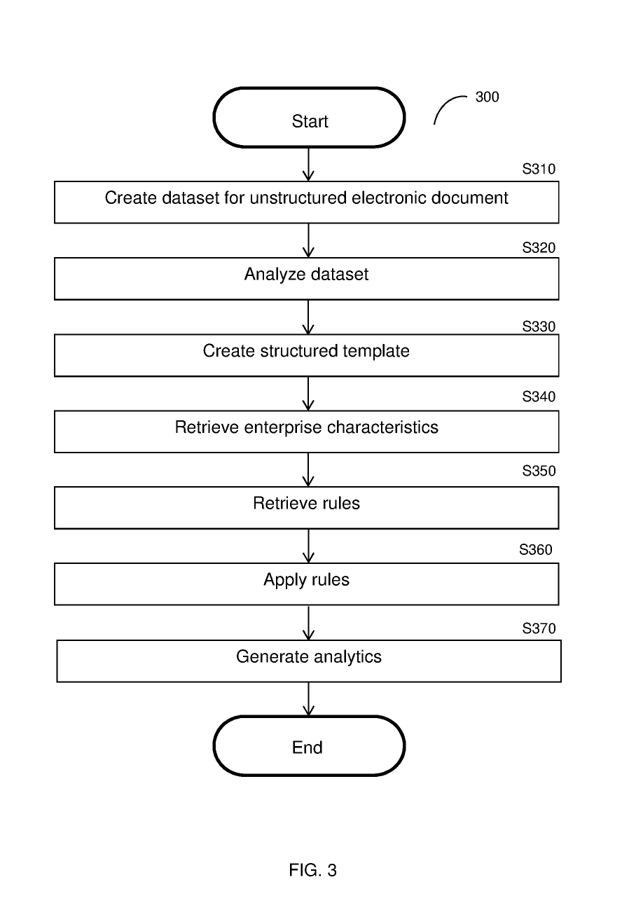

FIG. 3 is an example flowchart 300 illustrating a method for generating analytics based on electronic documents according to an embodiment. In an embodiment, the method may be performed by the analytics generator 120.

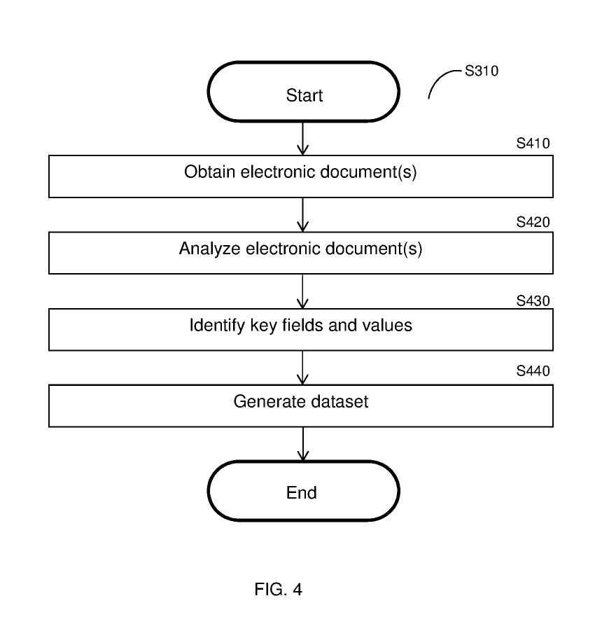

At S310, a dataset is created based on an evidencing electronic document including information related to a transaction. The transaction includes one or more expenses, and involves use of a payment card. The evidencing electronic document may include, but is not limited to, unstructured data, semi-structured data, structured data with structure that is unanticipated or unannounced, or a combination thereof. In an embodiment, S310 may further include analyzing the evidencing electronic document using optical character recognition (OCR) to determine data in the electronic document, identifying key fields in the data, identifying values in the data, or a combination thereof. Creating datasets based on electronic documents is described further herein below with respect to FIG. 4.

At S320, the created dataset is analyzed. In an embodiment, analyzing the dataset may include, but is not limited to, identifying transaction parameters such as, but not limited to, at least one entity identifier (e.g., a consumer enterprise identifier, a merchant enterprise identifier, or both), information related to the transaction (e.g., a date, a time, a price, a type of good or service sold, etc.), or both. In an example implementation, the transaction parameters include an amount for each expense, an identifier of a point of sale, and an identifier of a payment card. In a further embodiment, analyzing the expense report dataset may also include identifying the expenses of the transaction based on the expense report dataset.

At S330, a template is created based on the analyzed dataset. The template may be, but is not limited to, a data structure including a plurality of fields. The fields may include the identified transaction parameters. The fields may be predefined.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

In an embodiment, creating the template may further include retrieving supplemental data based on the identified transaction parameters and adding the supplemental data to the template. The supplemental data may provide further information related to the transaction that is not explicitly indicated in the evidencing electronic document. For example, the supplemental data may indicate more information about the point of sale, about the enterprise, or both. As a non-limiting example, based on an address in Copenhagen indicated in a “location of transaction” field of the template, supplemental data indicating that the point of sale located at that address is associated with the Hilton® Copenhagen Hotel may be retrieved.

At optional S340, based on the template, one or more enterprise characteristic parameters associated with an enterprise are retrieved. The enterprise may be an enterprise associated with the payment card indicated by the transaction parameters. To this end, S340 may include selecting a data source from which the enterprise characteristic parameters can be retrieved based on data in one or more fields of the created template. Alternatively or collectively, the enterprise characteristic parameters may be retrieved from a predetermined enterprise system, or an enterprise system indicated in a request for analytics.

At S350, rules for generating analytics are retrieved from one or more data sources. The rules may be retrieved based on the transaction parameters for the transaction, and may be further retrieved based on the enterprise characteristic parameters. Specifically, the rules may be based on the location of the transaction, the country of formation of the enterprise, the structure of the enterprise, recent revenue of the enterprise, and the like. In an example implementation, the rules may include rules for determining whether a VAT reclaim can be obtained for a transaction, whether expenses of the transaction are deductible, or both.

In an embodiment, S350 may include selecting the data sources from which the rules should be retrieved based on the template, the enterprise characteristic parameters, types of analytics to be generated (e.g., analytics indicating whether VAT reclaims are possible, analytics indicating whether expenses are deductible, etc.), or a combination thereof. For example, the selected data sources may include a server of a tax authority associated with the country of formation of the enterprise when deductible expense analytics are to be generated.

In some implementations, it is determined whether to apply at least a portion of the rules based on results from application of other rules. As a non-limiting example, if one or more expenses of the transaction are determined to be deductible based on deduction rules, it may be further determined whether a VAT can be reclaimed for the transaction.

At S360, the retrieved rules are applied to the transaction parameters, the evidencing electronic document, or both. The results the application may include, but is not limited to, a determination of whether a VAT reclaim can be obtained for a transaction, a determination of whether each expense is deductible, an amount that can be reclaimed or deducted, a combination thereof, and the like.

At S370, analytics are generated. The analytics indicate the results of the application. In an embodiment, S370 may further include generating a notification. The notification may include the generated analytics, and may further include the evidencing electronic document.

FIG. 4 is an example flowchart S310 illustrating a method for creating a dataset based on an electronic document according to an embodiment.

At S410, the electronic document is obtained. Obtaining the electronic document may include, but is not limited to, receiving the electronic document (e.g., receiving a scanned image) or retrieving the electronic document (e.g., retrieving the electronic document from a consumer enterprise system, a merchant enterprise system, or a database).

At S420, the electronic document is analyzed. The analysis may include, but is not limited to, using optical character recognition (OCR) to determine characters in the electronic document.

At S430, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to 12/12/2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key field values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated dataset includes the identified key fields and values.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating analytics based on an electronic document, comprising:
analyzing the electronic document to determine at least one transaction parameter, the electronic document indicating a transaction including use of a payment card with respect to at least one expense, wherein the electronic document includes at least partially unstructured data;
creating a template for the electronic document, wherein the template is a structured dataset including the determined at least one transaction parameter;
retrieving, based on the template, at least one deductibility rule for generating deductibility analytics; and
generating at least one deductibility analytic based on the template, at least one enterprise characteristic parameter of an enterprise associated with the payment card, and the retrieved at least one deductibility rule, wherein the at least one deductibility analytic indicates at least whether each of the at least one expense is deductible.

2. The method of claim 1, wherein determining the at least one transaction parameter further comprises:
identifying, in the electronic document, at least one key field and at least one value;
creating, based on the electronic document, a dataset, wherein the created dataset includes the at least one key field and the at least one value; and
analyzing the created dataset, wherein the at least one transaction parameter is determined based on the analysis.

3. The method of claim 2, wherein identifying the at least one key field and the at least one value further comprises:
analyzing the electronic document to determine data in the electronic document; and
extracting, based on a predetermined list of key fields, at least a portion of the determined data, wherein the at least a portion of the determined data matches at least one key field of the predetermined list of key fields.

4. The method of claim 3, wherein analyzing the electronic document further comprises:
performing optical character recognition on the electronic document.

5. The method of claim 1, wherein the at least one transaction parameter includes an identifier of the payment card, further comprising:
retrieving, from a data source associated with the enterprise, the at least one enterprise characteristic parameter based on the identifier of the payment card.

6. The method of claim 5, wherein the at least one deductibility rule is retrieved based further on the at least one enterprise characteristic parameter.

7. The method of claim 1, wherein the at least one deductibility analytic further indicates whether a value-added tax of the transaction can be reclaimed.

8. The method of claim 1, further comprising:
retrieving, from a payment card server, the electronic document, wherein the at least one deductibility rule is retrieved from a data source, wherein the data source is any of: a merchant device, a tax authority server, an accounting server, and a database associated with the enterprise.

9. The method of claim 8, wherein the at least one enterprise characteristic parameter is retrieved from the data source.

10. A non-transitory computer readable medium having stored thereon instructions for causing a processing circuitry to perform a process for generating analytics based on an electronic document, the process comprising:
analyzing the electronic document to determine at least one transaction parameter, the electronic document indicating a transaction including use of a payment card with respect to at least one expense, wherein the electronic document includes at least partially unstructured data;
creating a template for the electronic document, wherein the template is a structured dataset including the determined at least one transaction parameter;
retrieving, based on the template, at least one deductibility rule for generating deductibility analytics; and
generating at least one deductibility analytic based on the template, at least one enterprise characteristic parameter of an enterprise associated with the payment card, and the retrieved at least one deductibility rule, wherein the at least one deductibility analytic indicates at least whether each of the at least one expense is deductible.

11. A system for generating analytics based on an electronic document, comprising:
a processing circuitry; and
a memory, the memory containing instructions that, when executed by the processing circuitry, configure the system to:
analyze the electronic document to determine at least one transaction parameter, the electronic document indicating a transaction including use of a payment card with respect to at least one expense, wherein the electronic document includes at least partially unstructured data;
create a template for the electronic document, wherein the template is a structured dataset including the determined at least one transaction parameter;
retrieve, based on the template, at least one deductibility rule for generating deductibility analytics; and
generate at least one deductibility analytic based on the template, at least one enterprise characteristic parameter of an enterprise associated with the payment card, and the retrieved at least one deductibility rule, wherein the at least one deductibility analytic indicates at least whether each of the at least one expense is deductible.

12. The system of claim 11, wherein the system is further configured to:
identify, in the electronic document, at least one key field and at least one value;
create, based on the electronic document, a dataset, wherein the created dataset includes the at least one key field and the at least one value; and
analyze the created dataset, wherein the at least one transaction parameter is determined based on the analysis.

13. The system of claim 12, wherein the system is further configured to:
analyze the electronic document to determine data in the electronic document; and
extract, based on a predetermined list of key fields, at least a portion of the determined data, wherein the at least a portion of the determined data matches at least one key field of the predetermined list of key fields.

14. The system of claim 13, wherein the system is further configured to:
perform optical character recognition on the electronic document.

15. The system of claim 11, wherein the at least one transaction parameter includes an identifier of the payment card, wherein the system is further configured to:
retrieve, from a data source associated with the enterprise, the at least one enterprise characteristic parameter based on the identifier of the payment card.

16. The system of claim 15, wherein the at least one deductibility rule is retrieved based further on the at least one enterprise characteristic parameter.

17. The system of claim 11, wherein the at least one deductibility analytic further indicates whether a value-added tax of the transaction can be reclaimed.

18. The system of claim 11, wherein the system is further configured to:
retrieve, from a payment card server, the electronic document, wherein the at least one deductibility rule is retrieved from a data source, wherein the data source is any of: a merchant device, a tax authority server, an accounting server, and a database associated with the enterprise.

19. The system of claim 18, wherein the at least one enterprise characteristic parameter is retrieved from the data source
